(19) United States
(12) Patent Application Publication
(10) Pub. No.: US 2022/0188277 A1
(43) Pub. Date: Jun. 16, 2022

(54) APPARATUS, SYSTEM, AND METHOD FOR MANAGING AN OBJECT-BASED FILE SYSTEM

(71) Applicant: HITACHI VANTARA LLC, Santa Clara, CA (US)

(72) Inventors: Richard POWELL, Bracknell (GB); Michael BENSON, Bracknell (GB); Michael CARTER, Bracknell (GB); Gerard THORNLEY, Bracknell (GB); Matthew HANHAM, Bracknell (GB); David NORWOOD, Bracknell (GB)

(21) Appl. No.: 17/605,307

(22) PCT Filed: May 17, 2019
(86) PCT No.: PCT/US2019/032767

§ 371 Date: Oct. 21, 2021

(51) Int. Cl. G06F 16/182; G06F 16/174; G06F 16/14; G06F 21/62

(52) U.S. Cl. CPC G06F 16/1827; G06F 21/6218; G06F 16/148; G06F 16/1748

(57) ABSTRACT

An apparatus, system, and method for managing an object-based file system, and in particular for providing modifying access to an external application to a file system being managed in a user access restricted state, such as e.g. in the read only state. The apparatus including a network interface configured to communicably connect to one or more client computers via a communication network, and a file system management section, implemented at least in part by processor, configured to manage the object-based file system comprising plural file objects, each file object being associated with a respective file of the file system, the file system management section being configured to serve file access requests of a file serving protocol received via the interface. The file system management section is further configured to provide a block access object of the object-based file system being mountable as a block storage device.

The present disclosure relates to an apparatus, system, and method for managing an object-based file system.

### BACKGROUND

In the state of the art, it is known to provide file servers or file server systems managing file systems based on an object-based management, in which files and directories of a file system are managed as file system objects of an object layer level together with administrative objects including metadata of the file system. Above the object layer level, the files may be accessed from client computers by using file serving protocol communications. Below the object layer level, the data may be stored in logical blocks and each object includes metadata indicative of a mapping to one or more storage blocks associated with the respective file system objects.

Such file system management may include file system management operations such as deduplication, search indexing, making snapshots of the file system, establishing a sequence of checkpoints of the file system and file system replication.

While some file system management operations, such as replication of a source file system to a target file system, may require that the file system (e.g. the target file system) are managed in a user access restricted state, such as even in a read-only state, other file system management operations may require external processes to write index files or index databases, such as in case of search indexing or managing a deduplication index, and such managed index files or index databases may preferably be managed as part of the file system so as to be included in other file system management operations such as snapshot and checkpoint processing.

The present disclosure aims at providing a mechanism to enable restricting user access to file system objects of a file system, while efficiently allowing external processes to write data to or within the file system.

Accordingly, it is an object of the present disclosure to provide an apparatus, system, and method for managing an object-based file system, and in particular for enabling efficient modifying access to an external application to a file system being managed in a user access restricted state, such as e.g. in the read only state.

### SUMMARY

According to exemplary aspects, there is proposed an apparatus for managing an object-based file system, comprising a network interface configured to communicably connect to one or more client computers via a communication network, and a file system management section, implemented at least in part by processor, configured to manage the object-based file system comprising plural file objects, each file object being associated with a respective file of the file system, the file system management section being configured to serve file access requests of a file serving protocol received via the interface.

In some exemplary embodiments, the file system management section may be further configured to provide a block access object of the object-based file system being mountable as a block storage device.

Accordingly, efficient modifying access to the block access object can be provided for an external application to the file system, even if file access based on a file serving protocol may be managed in a user access restricted state, such as e.g. in the read only state.

In some exemplary embodiments, the file system management section may comprise a block serving protocol server section configured to serve block access requests of a block serving network protocol directed to the block storage device of the block access object of the object-based file system.

In some exemplary embodiments, the file system management section may be configured to provide the block access object of the object-based file system being mountable as a block storage device by a host operating system of a host computer.

In some exemplary embodiments, the file system management section may include a file serving application executed on the host operating system of a host computer.

In some exemplary embodiments, the file system management section may be configured to provide the block access object of the object-based file system to the host operating system of the host computer so as to format the block storage device provided by the block access object in the host operating system's file system format.

In some exemplary embodiments, the file system management section may be configured to provide the block access object of the object-based file system for write access by an external application executing on the host operating system of the host computer.

In some exemplary embodiments, the external application may be a search index application configured to create and/or update a search index based on file access requests issued to files associated with objects of the object-based file system.

In some exemplary embodiments, the file system management section may be configured to provide the block access object of the object-based file system for write access by the search index application to write into a search index file or search index database stored in the block access object.

In some exemplary embodiments, each object of the object-based file system may be associated with one or more respective storage blocks of a block level layer, and the file system management section may include a deduplication process section configured to perform a deduplication process at the block level layer, including calculating hash values of respective storage blocks of the block level layer and deduplicating storage blocks based on matching hash values.

In some exemplary embodiments, the external application may be a dedupe index application configured to create and/or update a dedupe index based on hash values shared by the deduplication process section via inter-process communication.

In some exemplary embodiments, the file system management section may be configured to provide the block access object of the object-based file system for write access by the dedupe index application to write into a dedupe index file or dedupe index database stored in the block access object.

In some exemplary embodiments, the file system management section may be configured to create the block access object at an object level layer of the object-based file system upon determining that the object-based file system is set to a user access restricted state.

In some exemplary embodiments, the file system management section may be configured to create the block access object upon determining that the object-based file system is set to a read-only state.

In some exemplary embodiments, the file system management section may be configured to create the block access object with associated object metadata.

In some exemplary embodiments, the object metadata of the block access object may be indicative of a block access type of the block access object.

In some exemplary embodiments, the object metadata of the block access object is indicative of a unique object number reserved for objects of a block access type.

According to further exemplary aspects, there may be provided a system including a host computer executing a host operating system, and an apparatus according to at least one of the above aspects and one or more of the above exemplary embodiments.

In some exemplary embodiments, the file system management section of the apparatus of the system may be configured to provide the block access object of the object-based file system being mountable as a block storage device by the host operating system of the host computer.

According to further exemplary aspects, there may be provided a method for managing an object-based file system, comprising managing, at least in part by a processor, an object-based file system comprising plural file objects, each file object being associated with a respective file of the file system, the file system management section being configured to serve file access requests of a file serving protocol received from one or more client computers, and providing a block access object of the object-based file system being mountable as a block storage device.

The method may also implement any functions and/or operations of at least one of the above aspects and one or more of the above exemplary embodiments.

According to further exemplary aspects, there may be provided a computer program product including computer-readable instructions that, when executed on a computer, cause the computer to execute the method(s) above.

While certain exemplary aspects have been described above, it is to be understood that such aspects are merely illustrative of and are not restrictive on the broad invention, and that the exemplary aspects are not limited to the specific constructions and arrangements shown and described above, since various other changes, combinations, omissions, modifications and substitutions, in addition to those set forth in the above paragraphs, are possible.

Those skilled in the art will appreciate that various adaptations, modifications, and/or combination of the just described aspects can be configured. Therefore, it is to be understood that, further aspects may be practiced other than as specifically described herein. For example, unless expressly stated otherwise, the steps of processes described herein may be performed in orders different from those described herein and one or more steps may be combined, split, or performed simultaneously.

Those skilled in the art will also appreciate, in view of this disclosure, that different aspects described herein may be combined to form other aspects of the present disclosure.

### BRIEF DESCRIPTION OF DRAWINGS

FIG. 1 is an exemplary schematic block diagram of a file storage system in accordance with some exemplary embodiments of the present invention.

FIG. 2 is an exemplary schematic block diagram of a file server in accordance with some exemplary embodiments of the present invention.

FIG. 3 is an exemplary schematic block diagram of an object-based file system management configuration in accordance with some exemplary embodiments of the present invention.

FIG. 4 is an exemplary schematic block diagram of an object tree structure in accordance with some exemplary embodiments of the present invention.

FIG. 5 is an exemplary schematic block diagram of a file system management system in accordance with some exemplary embodiments of the present invention.

FIG. 6 is an exemplary schematic block diagram of a file system management system in accordance with some other exemplary embodiments of the present invention.

FIG. 7 exemplarily illustrates a method for file system management, in particular for providing block access to an object of an object-based file system, in accordance with some exemplary embodiments.

### DETAILED DESCRIPTION OF DRAWINGS AND EXEMPLARY EMBODIMENTS

In the following, preferred aspects and embodiments of the present invention will be described in more detail with reference to the accompanying figures. Same or similar features in different drawings and embodiments are referred to by similar reference numerals. It is to be understood that the detailed description below relating to various preferred aspects and preferred embodiments are not to be meant as limiting the scope of the present invention.

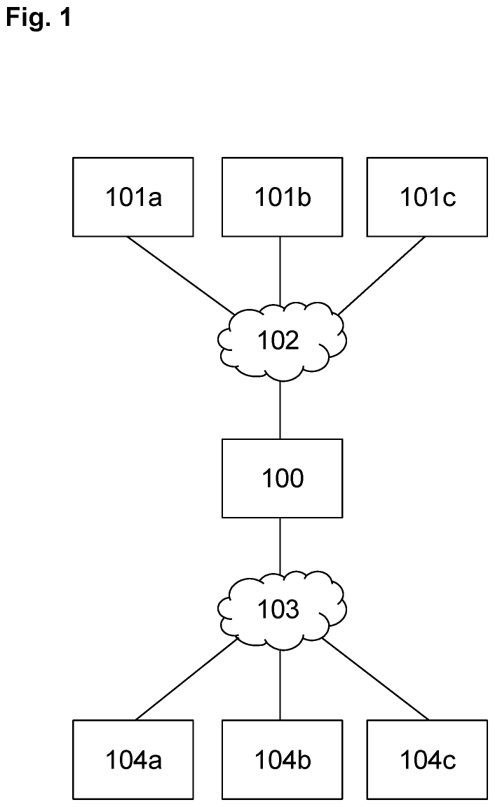

FIG. 1 is an exemplary schematic block diagram of a file storage system in accordance with some exemplary embodiments of the present invention.

Exemplarily, the file storage system includes a file server 100 (exemplarily, a single file server 100 is shown for the sake of simplicity and convenience, but the file storage system may also include multiple file servers, such as e.g. a file server cluster).

Exemplarily, the file server 100 is communicably connected to plural client computers 101a, 101b and 101c (client devices) via a communication network 102. The communication network 102 may include one or more local networks, such as e.g. LAN, WLAN, etc., and the communication network 102 may include one wider area networks, such as WAN, and/or a global network, such as e.g. the Internet or an Internet protocol network.

Further exemplarily, the file server 100 is communicably connected to plural storage devices 104a, 104b and 104c via a communication network 103, which may include a storage network or storage area network (SAN) or the like. The storage devices may 104a, 104b and 104c provide block storage for storing data, and the storage devices may, in some exemplary embodiments, be configured to store data in redundant fashion for data protection purposes, such as e.g. by a RAID configuration (RAID system).

In some exemplary embodiments, the file server 100 may be configured to enable file access via the network 102 using one or more file serving network protocols, such as e.g. SMB, CIFS and/or NFS.

In some exemplary embodiments, the file server 100 may be configured to communicate with the one or more storage devices 104a, 104b and 104c via the network 103 by using one or more block serving network protocols, such as e.g. Network Block Device, SCSI, Fibre Channel, iSCSI or Fibre Channel over Ethernet.

It should be noted that the file storage system could include multiple file servers and multiple RAID systems interconnected in various configurations, including a full mesh configuration in which any file server can communicate with any RAID system over a redundant and switched FibreChannel network.

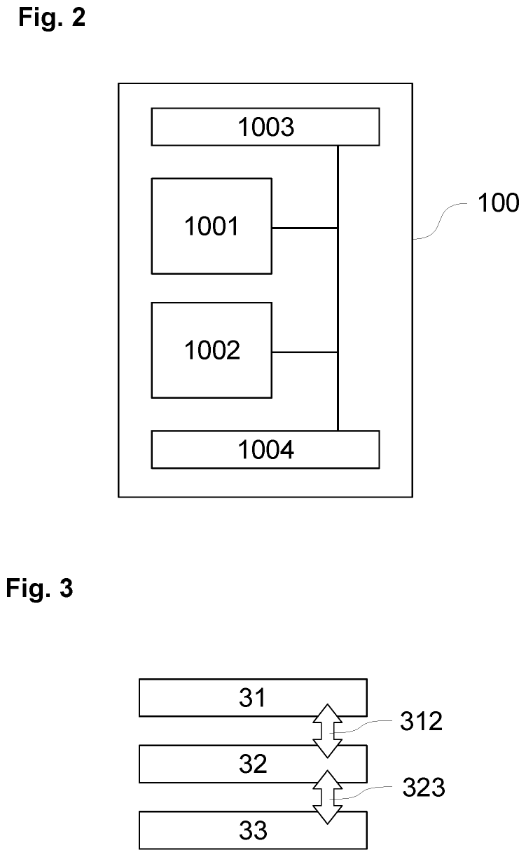

FIG. 2 is an exemplary schematic block diagram of a file server 100 in accordance with some exemplary embodiments of the present invention.

Exemplarily, the file server 100 includes a processing unit 1001, e.g. realized by one or more processors, and a storage unit 1002 for storing data and/or software for use by the processing unit 1001, the storage unit 1002 exemplarily including one or more memories such as ROM, RAM, cache, etc. and optionally further comprising storage such as storage drives such as hard disks and/or solid state drives.

Further exemplarily, the file server 100 includes a client network interface 1003 configured to communicate with the one or more client computers, such as client computers 101a, 101b and 101c, via the communication network 102, and a storage network interface 1004 configured to communicate with the one or more storage devices, such as storage devices 104a, 104b and 104c, via the communication network 103. In other exemplary embodiments, the file server 100 may include internal storage devices for block storage in addition or alternatively to the storage network interface 1004.

In other exemplary embodiments, when the storage system includes multiple file servers for distributed file system management, the file servers may further comprise file server interfaces for communicating with other file servers of the system.

Exemplarily, in some exemplary embodiments, the file server 100 (or the file server system cluster) may be configured to manage one or more file systems according to an object-based file system management.

FIG. 3 is an exemplary schematic block diagram of an object-based file system management configuration in accordance with some exemplary embodiments of the present invention.

The file system management configuration, as exemplarily managed by the file server 100 (or the file server system cluster) exemplarily includes a file level layer 31, an object level layer 32 and a block level layer 33.

The file level layer 31 exemplarily manages files (and directories) of one or more file systems. The object level layer 32 exemplarily manages objects of the one or more file systems, wherein each file (and further optionally each directory) of the file level layer 31 may exemplarily be associated with a respective file system object of the object level layer 32.

Finally, exemplarily, the block level layer 33 manages storage blocks (e.g. logical blocks) for data storage, wherein each object of the object level layer 32 may be associated with one or more storage blocks of the block level layer 33.

For the association of files (and optionally directories) with respective associated objects of the object level layer 32, the file server 100 (or the file server system cluster) may manage metadata 312. The metadata 312 may be indicative of associations of the files (and optionally directories) with respective associated objects of the object level layer 32.

In some exemplary embodiments, the metadata 312 may be managed as one or more metadata objects of the object level layer 32.

Accordingly, for each file system, the file server 100 (or the file server system cluster) may manage one or more file system objects, including file objects and/or directory objects, and one or more administrative objects, including one or more metadata objects, at the object level layer 32.

For the association of objects with respective storage blocks of the block level layer 33 (storing the data of the respective associated object), the file server 100 (or the file server system cluster) may manage metadata 323. The metadata 323 may be indicative of associations of the objects (file system objects and administrative/metadata objects) with respective associated storage blocks of the block level layer 33.

Accordingly, for each object, the file server 100 (or the file server system cluster) may manage one or more storage blocks storing metadata 323 and object data.

In some exemplary embodiments, the metadata 323 may be managed as a dynamic tree structure of the respective object.

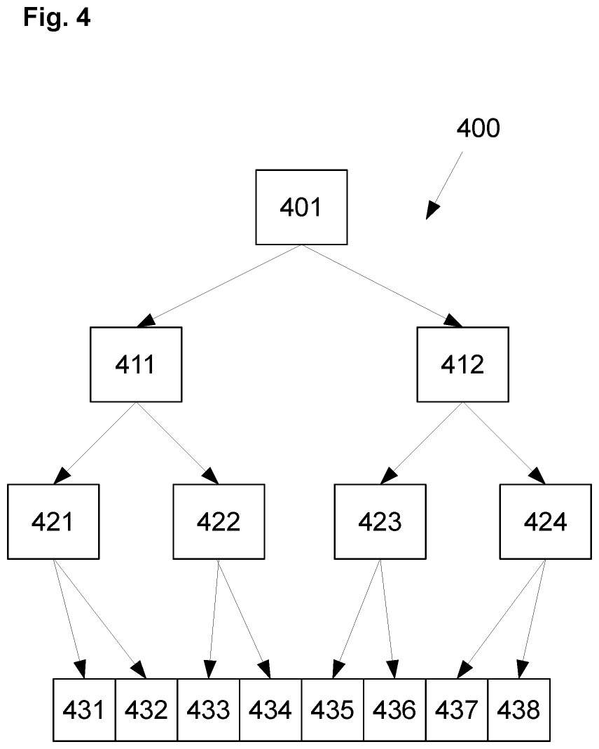

FIG. 4 is an exemplary schematic block diagram of an object tree structure of an object 400 in accordance with some exemplary embodiments of the present invention.

The object 400 exemplarily includes a tree structure of plural metadata nodes including a root metadata node 401, plural indirect metadata nodes 411 and 412, plural direct metadata nodes 421, 422, 423 and 424, and plural storage blocks 431 to 438.

Exemplarily, the root metadata node 401 includes pointers (exemplarily illustrated by arrows) which point to the indirect metadata nodes 411 and 412, the indirect metadata nodes 411 and 412 include pointers which point to respective ones of the direct metadata nodes 421 to 424, and the direct metadata nodes 421 to 424 include pointers which point to respective ones of the plural storage blocks 431 to 438.

When data is written to a certain object, the data can be written to further storage blocks, which may at that time be additionally allocated to the certain object, and additional metadata nodes and/or additional pointers may be dynamically added to the tree structure. The tree structure may include also plural levels of indirect nodes. In general, a direct metadata node is a metadata node including pointers directly pointing to storage blocks, while indirect metadata nodes are metadata nodes that point to other metadata nodes, such as other indirect metadata nodes and/or direct metadata nodes.

In some exemplary aspects, the file server 100 (of file server cluster system) may manage a certain special metadata object (e.g. referred to as indirection object) at the object level associating file identifiers (such as e.g. file handles) with objects.

Then, when a user (client computer) sends a file access request of a certain file serving protocol, the request being indicative of a file identifier of a file to be accessed and an offset of data to be accessed within the targeted file, then the file server may traverse the object tree of the certain special metadata object (indirection object) so as to identify the associated object identifier of the associated file object.

Then, e.g. based on the offset indicated in the file access request, the file server may traverse the object tree of the associated file object so as to access the storage block(s) corresponding to the indicated offset and the requested data length.

Now, in certain circumstances, it may be desirable to restrict the user access to a file system managed by the file server, e.g. by establishing certain access permissions or making the file system read-only completely.

Restricted user access may mean that modifying access such as write access is at least partially prohibited and/or disabled. When the file system is being read-only, then read access to the file system is allowed/enabled while modifying access (such as write access) is prohibited/disabled.

For example, the file system may be made read-only when it is a target file system of a replication process replicating another source file system, wherein the source file system may be still accessible, and modifications performed in the source file system are replicated to the target file system. In order to keep the target file system consistent with the source file system, independent user access (other than read access) to the target file system needs to be disabled.

Still, it may be desirable for file systems with restricted user access (such as e.g. read only file systems) to perform operations that may require to write data and/or metadata such as index files (e.g. search indexes for search purposes and/or deduplication indexes for deduplication purposes), wherein the written data shall be kept as a part of the file system (e.g. as metadata associated with the file system), so as to be moved with the file system, when moving the file system, and/or to be integrated/included in certain file system operations, such as in creating file system snapshots or file system checkpoints.

For such purposes, it is proposed, in some exemplary embodiments, to provide exemplary novel concepts and exemplary mechanisms that allow to write certain data within a file system which is (at least currently, e.g. temporarily or permanently) managed with restricted user access or even as a read-only file system.

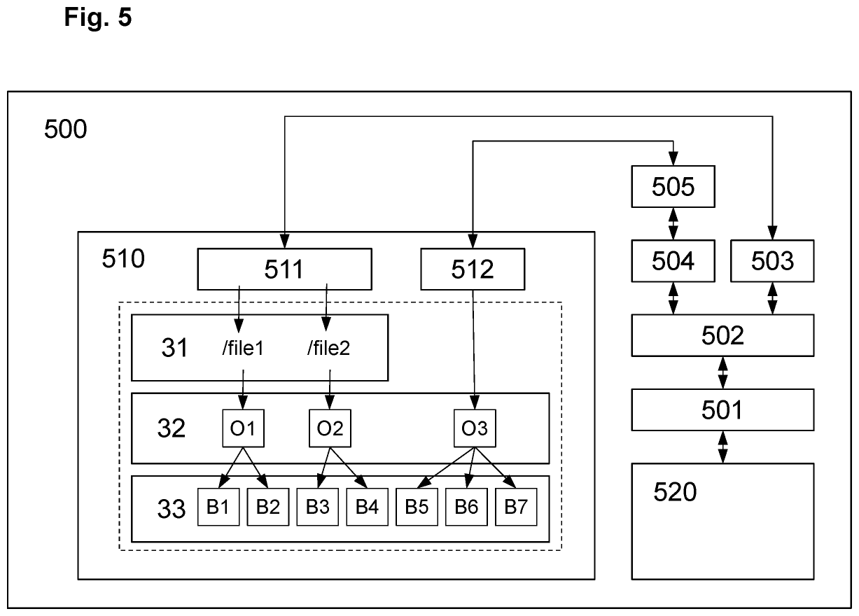

FIG. 5 is an exemplary schematic block diagram of a file system management system in accordance with some exemplary embodiments of the present invention.

Exemplarily, such file system management system may be implemented on a file server 100 or on file servers of a file server system as exemplarily described in above exemplary aspects.

The file system management system may operate an operating system (OS) layer of an operating system 500. Exemplarily, a file system management section 510 is configured to execute operations or processes on the operating system 500.

The file system management section 510 is exemplarily configured to manage one or more file systems according to a layered structure (dashed box in FIG. 5), including a file level layer 31, an object level layer 32 and a storage block level layer 33, e.g. similar as discussed in connection with FIG. 3 above.

The file system management section 510 exemplarily includes a file serving protocol server section 511 configured to receive and serve file serving protocol access requests according to one or more file serving network protocols, such as e.g. SMB, CIFS and/or NFS.

The file serving protocol server section 511 enables access of files of the file level layer 31, e.g. /file1 and /file2 of a file system. As exemplarily discussed in connection with FIG. 3, the files of the file system may be associated with respective file system objects of the object level layer 32. For example, the file /file1 is associated with the file system object O1 and the /file2 is associated with the file system object O2.

Furthermore, each object of the object level layer 32 is associated with respective (one or more) storage blocks of the block level layer 33. For example, the object O1 is associated with the storage blocks B1 and B2 and the object O2 is associated with the storage blocks B3 and B4.

Accordingly, the file /file1 of the file system is exemplarily managed as file system object O1 which stores file data of /file1 in the associated storage blocks B1 and B2, and the file /file2 of the file system is exemplarily managed as file system object O2 which stores file data of /file2 in the associated storage blocks B3 and B4.

As discussed above, when further data is written to any of the files, the respective associated object can be dynamically extended by allocating further blocks to the respective object and adapting the object's metadata (such as e.g. its metadata tree).

The file serving protocol server section 511 can be accessed by a corresponding file serving protocol client using the compatible file serving network protocol, e.g. from an external client computer for establishing user access to the managed file system or from the file serving protocol client section 503 configured/operated on the operating system layer of the operating system 500.

In other words, the file serving protocol server section 511 can provide the managed file system for access as a share or export, depending on the parlance of the respective file serving network protocol, either externally for client computers or internally for the operating system 500 and applications executed thereon.

Accordingly, when an application 520 is executed on the operating system 500, the application 520 can access a virtual file system (OS virtual file system) managed by the operating system 500 and provided by the operating system's file system driver 502 configured to communicate with the file serving protocol client section 503.

In other words, the file system managed by the file system management section 510 can be provided to the application 520 as a shared/exported file system of the virtual file system 501 of the operating system 500 via the file serving protocol client section 503 and the OS file system driver 502.

On the other hand, when the user access to the file system managed by the file system management section 510 is (partially) restricted or when the file system managed by the file system management section 510 is even made read-only, then such file system access by the application 520 is restricted or even limited to read-only access, and write access may be restricted or even prohibited.

However, in some cases, it may be desirable that the application 520 may write data even to a file system with restricted user access or even to a read-only file system.

For example, in FIG. 5 it may be assumed that the application 520 is an indexing application configured to create a search index associated with data stored in the file system to be stored in an index file or index database that shall be managed together with the indexed file system.

Then, even when the user access to the file system is restricted or even when the file system is read-only, it may be desirable that the indexing application 520 may continue to write to the index file or index database of the file system.

Exemplarily, this may be achieved in some exemplary embodiments by providing a special type of file system object in the file system, which file system object may be accessed via a block serving network protocol, such as e.g. Network Block Device, SCSI, Fibre Channel, iSCSI or Fibre Channel over Ethernet.

For this purpose, a special object O3 may be created in the file system managed by the file system management section 510 on the object layer 32 (exemplarily without any association with a file on the file layer 31) e.g. as an administrative object or metadata object.

As such, the special object O3 may still be subject to file system operations such as being considered in snapshots or checkpoint mechanisms of the file system management of the file system management section 510.

For accessing the special object O3, the file system management section 510 exemplarily includes a block serving protocol server section 512. Exemplarily, the special object O3 is associated with storage blocks B5 to B7 at the block level layer 33.

For creating or modifying the search index based on indexing the file system objects such as objects O1 and O2 associated with regular files of the file system managed by the file system management section 510, the application 520 may still read files through the above mechanism via file serving protocol client section 503.

However, since write access to the file system may be restricted or prohibited (e.g. in case of a read-only file system), the index file or index database may be written to the special object O3 via a different mechanism in some exemplary embodiments.

Exemplarily, the special object O3 may be provided as a block serving protocol volume (may also be referred to as a “block” in block serving protocol parlance, but to be distinguished from the storage blocks of the block level layer 33, it is herein referred to as volume or “BLOCK”).

In other words, the operating system 500 may be enabled to mount the BLOCK as a volume or block device so as to format the volume of the BLOCK as a virtual file system of the operating system 500, i.e. to be pretended to represent a local file system of the operating system 500. That is, the operating system 500 is enabled to mount the special object O3 as a virtual local OS file system, e.g. for storing the index file or index database of the application 520.

The operating system 500 further exemplarily includes a block serving protocol client section 505 in communication with the block serving protocol server section 512 of the file system management section 510.

The operating system 500 further exemplarily includes an OS block driver 504 in communication with the block serving protocol client section 505 of the operating system 500 and the OS file system driver 502 of the operating system 500.

Accordingly, the application 520 can access the virtual file system mounted from the special object O3 through the virtual file system 501, the OS file system driver 502, the OS block driver 504, the block serving protocol client section 505, and the block serving protocol server section 512 of the file system management section 510, e.g. for writing the search index file or the search index database into the virtual file system provided by the special object O3.

In the above example, the application 520 can write to the special object O3 in an unrestricted manner even when the regular access to the file system managed by the file system management section 510 is restricted or even when the file system is made (temporarily or permanently) read only.

In the above, the mechanism was described in connection with an exemplary indexing application 520 which, for example, creates and/or updates a search index based on the file system managed by the file system management section 510 and writes a search index file or search index database into the special object O3 of the file system managed by the file system management section 510.

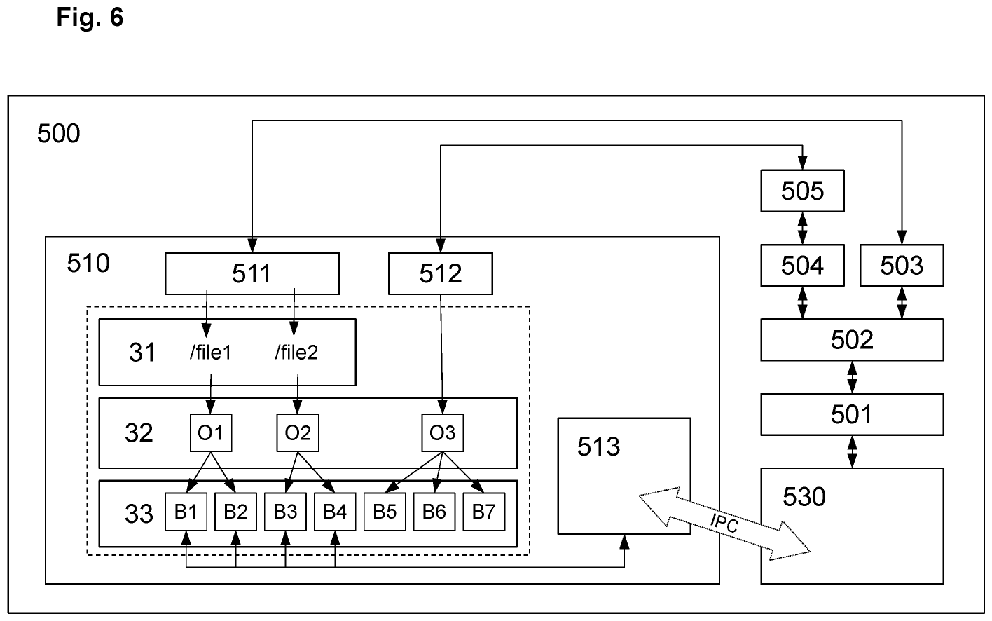

However, in other exemplary embodiments, the similar principles may be applied to or used in file system deduplication, as for example discussed in connection with FIG. 6 below.

FIG. 6 is an exemplary schematic block diagram of a file system management system in accordance with some other exemplary embodiments of the present invention.

In FIG. 6, the file system management section 510 exemplarily further includes a deduplication process application 513 configured to execute a deduplication process within the file system(s) managed by the file system management section 510.

For example, the deduplication process application 513 may be configured to execute a deduplication process in which the deduplication process application 513 reads data of storage blocks of the storage block level layer 33 e.g. to calculate a hash value for each storage block (storing user data or file system object data).

Then, if a hash value matches a previously found hash value, indicating that the respective storage block stores data identical to data stored already in another storage block, the deduplication process application 513 may be configured to deduplicate the respective storage blocks by replacing one of the storage blocks with a pointer or reference to the other storage block, thereby enabling freeing the replaced block for further use so as to more efficiently manage storage space.

However, it may be beneficial to use an external application, such as the dedupe index application 530 for creating or updating the dedupe index of hashed values and associations to the already hashed storage blocks.

Exemplarily, the dedupe index application 530 for creating or updating the dedupe index externally operates on the operating system 500 and communicates with the deduplication process application 513 of the file system management section 510, e.g., via inter-process communication as indicated by the arrow IPC in FIG. 6.

Still, it may be desired to keep/store the dedupe index (e.g. as one or more dedupe index files or a dedupe index database) within the file system managed by the file system management section 510, preferably even if the access to the file system may be restricted or even if the file system may be read-only.

Similar to FIG. 5, the file system managed by the file system management section 510 includes a special object O3 on the object level layer 32. That is, the special object O3 may be created in the file system managed by the file system management section 510 on the object level layer 32 (exemplarily without any association with a file on the file layer 31) e.g. as an administrative object or metadata object.

As such, the special object O3 may still be subject to file system operations such as being considered in snapshots or checkpoint mechanisms of the file system management of the file system management section 510.

For accessing the special object O3, the file system management section 510 exemplarily includes the block serving protocol server section 512. Exemplarily, the special object O3 is associated with storage blocks B5 to B7 at the block level layer 33.

For creating or modifying or updating the dedupe index based on hash values obtained from the deduplication process application 513 e.g. via the inter-process communication IPC, the application 530 may, even when write access to the file system may be restricted or prohibited (e.g. in case of a read-only file system), write to the dedupe index file or dedupe index database to the special object O3.

Exemplarily, the special object O3 may be provided as a block serving protocol volume, i.e. as volume or “BLOCK”).

In other words, the operating system 500 may be enabled to mount the BLOCK as a volume or block device so as to format the volume of the BLOCK as a virtual file system of the operating system 500, i.e. to be pretended to represent a local file system of the operating system 500.

That is, the operating system 500 is enabled to mount the special object O3 as a virtual local OS file system, e.g. for storing the dedupe index file or dedupe index database of the application 530.

The operating system 500 further exemplarily includes a block serving protocol client section 505 in communication with the block serving protocol server section 512 of the file system management section 510.

The operating system 500 further exemplarily includes an OS block driver 504 in communication with the block serving protocol client section 505 of the operating system 500 and the OS file system driver 502 of the operating system 500.

Accordingly, the application 530 can access the virtual file system mounted from the special object O3 through the virtual file system 501, the OS file system driver 502, the OS block driver 504, the block serving protocol client section 505, and the block serving protocol server section 512 of the file system management section 510, e.g. for writing/updating the dedupe index file or the dedupe index database into the virtual file system provided by the special object O3.

In the above example, the dedupe indexing application 530 can write to the special object O3 in an unrestricted manner even when the regular access to the file system managed by the file system management section 510 is restricted or even when the file system is made (temporarily or permanently) read only.

It is to be noted that in some exemplary embodiments, including FIGS. 5 and 6, the size of the BLOCK (block volume) provided by the special object O3 can be dynamically changed, e.g. increased, by exemplarily allocating further storage blocks of the block level layer 33 to the special object O3.

Specifically, the metadata associating the special object O3 with its associated storage blocks of the block level layer 33 may be managed by the file system management section 510 similar to other objects of the file system managed by the file system management section 510, e.g. based on a tree structure as shown e.g. in FIG. 4.

In some preferred exemplary embodiments, the block serving protocol server section 512 is aware of the size of the special object O3 and the size of the storage blocks of the block level layer 33 so as to provide efficient access, e.g. by accessing the special object O3 in chunks having a chunk size equal to the size of the storage blocks of the block level layer 33.

In some exemplary embodiments, including for the configurations of FIGS. 5 and 6, the file system management section 510 may manage one or more special objects for block serving protocol access via the block serving protocol server section 512, and the object's metadata may be indicative of a type of the special object, e.g. the type of the special object being indicative that the special object is enabled for block access (e.g. by a type BLOCK_ACCESS.

Also, in order to be easily identifiable and for more efficient file system management, each of one or more special objects may be associated with a unique permanent object number, whereas regular file system objects may be dynamically assigned with currently unique object numbers.

Also, the unique permanent object number of such special object may be permanently associated with a certain associated application (e.g. applications 520 and 530 above, respectively), e.g. by unique object numbers such as DEDUPE_INDEX_BLOCK_ACCESS for the application 530 above and SEARCH_INDEX_BLOCK_ACCESS for the application 520 above, etc.

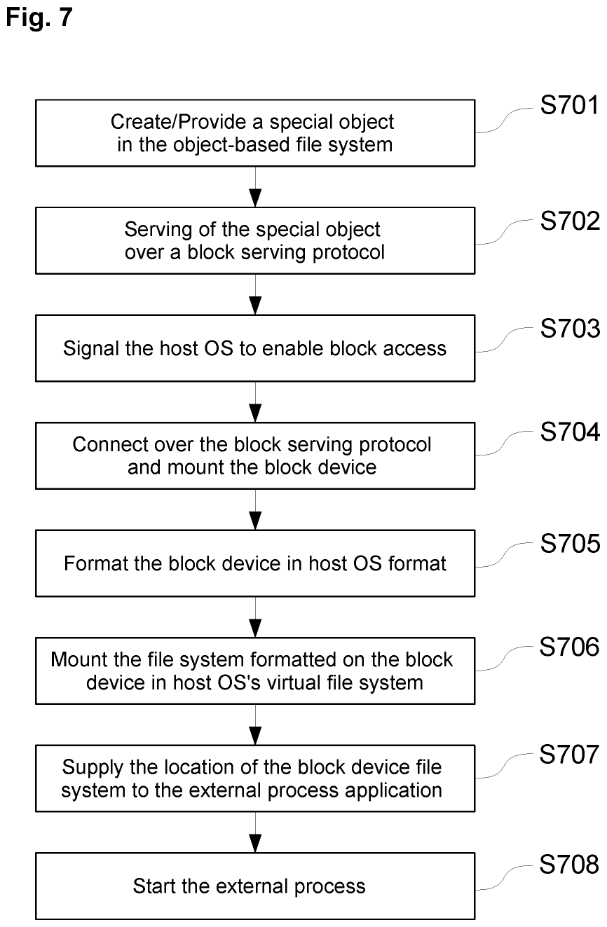

FIG. 7 exemplarily illustrates a method for file system management, in particular for providing block access to an object of an object-based file system, in accordance with some exemplary embodiments.

In step S701, a (new) special object in the object-based file system is created or, if previously created by the file system management section, the special object in the object-based file system is provided. The file system management section may operate on top of a host operating system or be in communication with a host running a host operating system.

In step S702, the serving of the special object over a block serving protocol is started by the file system management section.

In step S703, the file system management section may send a signal to the host operating system to enable block access to the special object as a block device (e.g. a volume).

In step S704, upon receiving the signal, the host operating system connects over the block serving protocol and mounts the block device.

Optionally, e.g. if the special object has not been used before, the host operating system formats the block device in step S705 to provide an OS file system e.g. in the host's own format.

In step S706, the host operating system mounts the file system formatted on the block device into the host operating system's virtual file system.

In step S707, the host operating system supplies information indicative of the location of the block device file system to the external process application, such as e.g. applications 520 and/or 530 above.

In step S708, the external process application starts, possibly accessing the block device file system formatted on the block device provided by the special object of the object-based file system via a block serving network protocol, such as e.g. Network Block Device, SCSI, Fibre Channel, iSCSI or Fibre Channel over Ethernet.

Summarizing, in some exemplary embodiments, a new file system object with a known unique object number may be created and/or provided, and access to that new special object can be made available to one or more external processes over a network protocol that is designed for storage block access. That is, access at the object level can bypass an access-restricted state or even read-only state of the file system.

The use of a new special object may ensure that data being protected by the access-restricted state or even read-only state of the file system is unaffected by the newly enabled read/write access via block access.

In some exemplary embodiments, a host operating system driver and client may be provided to allow the host operating system to create and/or format a (local and/or virtual) file system into the virtual storage BLOCK that is served over the block serving network protocol.

The host OS file system can then be mounted and be made available for use by external processes or applications such as e.g. a deduplication indexing application or a search indexing application.

As will be appreciated by one of skill in the art, the present invention, as described hereinabove and the accompanying figures, may be embodied as a method (e.g., a computer-implemented process, a business process, or any other process), apparatus (including a device, machine, system, computer program product, and/or any other apparatus), or a combination of the foregoing.

Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system”. Furthermore, embodiments of the present invention may take the form of a computer program product on a computer-readable medium having computer-executable program code embodied in the medium.

It should be noted that arrows may be used in drawings to represent communication, transfer, or other activity involving two or more entities. Double-ended arrows generally indicate that activity may occur in both directions (e.g., a command/request in one direction with a corresponding reply back in the other direction, or peer-to-peer communications initiated by either entity), although in some situations, activity may not necessarily occur in both directions.

Single-ended arrows generally indicate activity exclusively or predominantly in one direction, although it should be noted that, in certain situations, such directional activity actually may involve activities in both directions (e.g., a message from a sender to a receiver and an acknowledgement back from the receiver to the sender, or establishment of a connection prior to a transfer and termination of the connection following the transfer). Thus, the type of arrow used in a particular drawing to represent a particular activity is exemplary and should not be seen as limiting.

Embodiments of the present invention are described hereinabove with reference to flowchart illustrations and/or block diagrams of methods and apparatuses, and with reference to a number of sample views of a graphical user interface generated by the methods and/or apparatuses. It will be understood that each block of the flowchart illustrations and/or block diagrams, and/or combinations of blocks in the flowchart illustrations and/or block diagrams, as well as the graphical user interface, can be implemented by computer-executable program code.

The computer-executable program code may be provided to a processor of a general purpose computer, special purpose computer, or other programmable data processing apparatus to produce a particular machine, such that the program code, which executes via the processor of the computer or other programmable data processing apparatus, create means for implementing the functions/acts/outputs specified in the flowchart, block diagram block or blocks, figures, and/or written description.

These computer-executable program code may also be stored in a computer-readable memory that can direct a computer or other programmable data processing apparatus to function in a particular manner, such that the program code stored in the computer readable memory produce an article of manufacture including instruction means which implement the function/act/output specified in the flowchart, block diagram block(s), figures, and/or written description.

The computer-executable program code may also be loaded onto a computer or other programmable data processing apparatus to cause a series of operational steps to be performed on the computer or other programmable apparatus to produce a computer-implemented process such that the program code which executes on the computer or other programmable apparatus provides steps for implementing the functions/acts/outputs specified in the flowchart, block diagram block(s), figures, and/or written description. Alternatively, computer program implemented steps or acts may be combined with operator or human implemented steps or acts in order to carry out an embodiment of the invention.

It should be noted that terms such as “server” and “processor” may be used herein to describe devices that may be used in certain embodiments of the present invention and should not be construed to limit the present invention to any particular device type unless the context otherwise requires. Thus, a device may include, without limitation, a bridge, router, bridge-router (brouter), switch, node, server, computer, appliance, or other type of device. Such devices typically include one or more network interfaces for communicating over a communication network and a processor (e.g., a microprocessor with memory and other peripherals and/or application-specific hardware) configured accordingly to perform device functions.

Communication networks generally may include public and/or private networks; may include local-area, wide-area, metropolitan-area, storage, and/or other types of networks; and may employ communication technologies including, but in no way limited to, analog technologies, digital technologies, optical technologies, wireless technologies (e.g., Bluetooth), networking technologies, and internetworking technologies.

It should also be noted that devices may use communication protocols and messages (e.g., messages created, transmitted, received, stored, and/or processed by the device), and such messages may be conveyed by a communication network or medium.

Unless the context otherwise requires, the present invention should not be construed as being limited to any particular communication message type, communication message format, or communication protocol. Thus, a communication message generally may include, without limitation, a frame, packet, datagram, user datagram, cell, or other type of communication message.

Unless the context requires otherwise, references to specific communication protocols are exemplary, and it should be understood that alternative embodiments may, as appropriate, employ variations of such communication protocols (e.g., modifications or extensions of the protocol that may be made from time-to-time) or other protocols either known or developed in the future.

It should also be noted that logic flows may be described herein to demonstrate various aspects of the invention, and should not be construed to limit the present invention to any particular logic flow or logic implementation. The described logic may be partitioned into different logic blocks (e.g., programs, modules, functions, or subroutines) without changing the overall results or otherwise departing from the true scope of the invention.

Often times, logic elements may be added, modified, omitted, performed in a different order, or implemented using different logic constructs (e.g., logic gates, looping primitives, conditional logic, and other logic constructs) without changing the overall results or otherwise departing from the true scope of the invention.

The present invention may be embodied in many different forms, including, but in no way limited to, computer program logic for use with a processor (e.g., a microprocessor, microcontroller, digital signal processor, or general purpose computer), programmable logic for use with a programmable logic device (e.g., a Field Programmable Gate Array (FPGA) or other PLD), discrete components, integrated circuitry (e.g., an Application Specific Integrated Circuit (ASIC)), or any other means including any combination thereof Computer program logic implementing some or all of the described functionality is typically implemented as a set of computer program instructions that is converted into a computer executable form, stored as such in a computer readable medium, and executed by a microprocessor under the control of an operating system. Hardware-based logic implementing some or all of the described functionality may be implemented using one or more appropriately configured FPGAs.

Computer program logic implementing all or part of the functionality previously described herein may be embodied in various forms, including, but in no way limited to, a source code form, a computer executable form, and various intermediate forms (e.g., forms generated by an assembler, compiler, linker, or locator).

Source code may include a series of computer program instructions implemented in any of various programming languages (e.g., an object code, an assembly language, or a high-level language such as Fortran, C, C++, JAVA, or HTML) for use with various operating systems or operating environments. The source code may define and use various data structures and communication messages. The source code may be in a computer executable form (e.g., via an interpreter), or the source code maybe converted (e.g., via a translator, assembler, or compiler) into a computer executable form.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Computer program logic implementing all or part of the functionality previously described herein may be executed at different times on a single processor (e.g., concurrently) or may be executed at the same or different times on multiple processors and may run under a single operating system process/thread or under different operating system processes/threads.

Thus, the term “computer process” refers generally to the execution of a set of computer program instructions regardless of whether different computer processes are executed on the same or different processors and regardless of whether different computer processes run under the same operating system process/thread or different operating system processes/threads.

The computer program may be fixed in any form (e.g., source code form, computer executable form, or an intermediate form) either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), a PC card (e.g., PCMCIA card), or other memory device.

The computer program may be fixed in any form in a signal that is transmittable to a computer using any of various communication technologies, including, but in no way limited to, analog technologies, digital technologies, optical technologies, wireless technologies (e.g., Bluetooth), networking technologies, and internetworking technologies.

The computer program may be distributed in any form as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web).

Hardware logic (including programmable logic for use with a programmable logic device) implementing all or part of the functionality previously described herein may be designed using traditional manual methods, or may be designed, captured, simulated, or documented electronically using various tools, such as Computer Aided Design (CAD), a hardware description language (e.g., VHDL or AHDL), or a PLD programming language (e.g., PALASM, ABEL, or CUPL).

Any suitable computer readable medium may be utilized. The computer readable medium may be, for example but not limited to, an electronic, magnetic, optical, electromagnetic, infrared, or semiconductor system, apparatus, device, or medium.

More specific examples of the computer readable medium include, but are not limited to, an electrical connection having one or more wires or other tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Programmable logic may be fixed either permanently or transitorily in a tangible storage medium, such as a semiconductor memory device (e.g., a RAM, ROM, PROM, EEPROM, or Flash-Programmable RAM), a magnetic memory device (e.g., a diskette or fixed disk), an optical memory device (e.g., a CD-ROM), or other memory device.

The programmable logic may be fixed in a signal that is transmittable to a computer using any of various communication technologies, including, but in no way limited to, analog technologies, digital technologies, optical technologies, wireless technologies (e.g., Bluetooth), networking technologies, and internetworking technologies.

The programmable logic may be distributed as a removable storage medium with accompanying printed or electronic documentation (e.g., shrink wrapped software), preloaded with a computer system (e.g., on system ROM or fixed disk), or distributed from a server or electronic bulletin board over the communication system (e.g., the Internet or World Wide Web). Of course, some embodiments of the invention may be implemented as a combination of both software (e.g., a computer program product) and hardware. Still other embodiments of the invention are implemented as entirely hardware, or entirely software.

While certain exemplary embodiments have been described and shown in the accompanying drawings, it is to be understood that such embodiments are merely illustrative of and are not restrictive on the broad invention, and that the embodiments of invention are not limited to the specific constructions and arrangements shown and described, since various other changes, combinations, omissions, modifications and substitutions, in addition to those set forth in the above paragraphs, are possible.

Those skilled in the art will appreciate that various adaptations, modifications, and/or combination of the just described embodiments can be configured without departing from the scope and spirit of the invention. Therefore, it is to be understood that, within the scope of the appended claims, the invention may be practiced other than as specifically described herein. For example, unless expressly stated otherwise, the steps of processes described herein may be performed in orders different from those described herein and one or more steps may be combined, split, or performed simultaneously.

Those skilled in the art will also appreciate, in view of this disclosure, that different embodiments of the invention described herein may be combined to form other embodiments of the invention.

1. Apparatus for managing an object-based file system, comprising:
a network interface configured to communicably connect to one or more client computers via a communication network; and
a file system management section, implemented at least in part by a processor, configured to manage the object-based file system comprising plural file objects, each file object being associated with a respective file of the file system,
the file system management section being configured to serve file access requests of a file serving protocol received via the interface;
wherein the file system management section is further configured to provide a block access object of the object-based file system being mountable as a block storage device.

2. Apparatus according to claim 1, wherein
the file system management section comprises a block serving protocol server section configured to serve block access requests of a block serving network protocol directed to the block storage device of the block access object of the object-based file system.

3. Apparatus according to claim 1, wherein
the file system management section is configured to provide the block access object of the object-based file system being mountable as a block storage device by a host operating system of a host computer.

4. Apparatus according to claim 3, wherein
the file system management section includes a file serving application executed on the host operating system of a host computer.

5. Apparatus according to claim 3, wherein
the file system management section is configured to provide the block access object of the object-based file system to the host operating system of the host computer so as to format the block storage device provided by the block access object in the host operating system's file system format.

6. Apparatus according to claim 3, wherein
the file system management section is configured to provide the block access object of the object-based file system for write access by an external application executing on the host operating system of the host computer.

7. Apparatus according to claim 6, wherein
the external application is a search index application configured to create and/or update a search index based on file access requests issued to files associated with objects of the object-based file system, and
the file system management section is configured to provide the block access object of the object-based file system for write access by the search index application to write into a search index file or search index database stored in the block access object.

8. Apparatus according to claim 6, wherein
each object of the object-based file system is associated with one or more respective storage blocks of a block level layer, and
the file system management section includes a deduplication process section configured to perform a deduplication process at the block level layer, including calculating hash values of respective storage blocks of the block level layer and deduplicating storage blocks based on matching hash values,
wherein the external application is a dedupe index application configured to create and/or update a dedupe index based on hash values shared by the deduplication process section via inter-process communication, and
wherein the file system management section is configured to provide the block access object of the object-based file system for write access by the dedupe index application to write into a dedupe index file or dedupe index database stored in the block access object.

9. Apparatus according to claim 1, wherein
the file system management section is configured to create the block access object at an object level layer of the object-based file system upon determining that the object-based file system is set to a user access restricted state.

10. Apparatus according to claim 9, wherein
the file system management section is configured to create the block access object upon determining that the object-based file system is set to a read-only state.

11. Apparatus according to claim 9, wherein
the file system management section is configured to create the block access object with associated object metadata.

12. Apparatus according to claim 11, wherein
the object metadata of the block access object is indicative of a block access type of the block access object; and/or
the object metadata of the block access object is indicative of a unique object number reserved for objects of a block access type.

13. System including
a host computer executing a host operating system, and
an apparatus for managing an object-based file system;
the apparatus comprising:
a network interface configured to communicably connect to one or more client computers via a communication network, and
a file system management section, implemented at least in part by a processor, configured to manage the object-based file system comprising plural file objects, each file object being associated with a respective file of the file system;
wherein the file system management section of the apparatus is configured to serve file access requests of a file serving protocol received via the interface; and
wherein the file system management section of the apparatus is configured to provide the block access object of the object-based file system being mountable as a block storage device by the host operating system of the host computer.

14. Method for managing an object-based file system, comprising:
managing, at least in part by a processor, an object-based file system comprising plural file objects, each file object being associated with a respective file of the file system, the file system management section being configured to serve file access requests of a file serving protocol received from one or more client computers, and
providing a block access object of the object-based file system being mountable as a block storage device.

15. Computer program product including computer-readable instructions that, when executed on a computer, cause the computer to execute the method of claim 14.
